(19) United States
(12) Patent Application Publication
(10) Pub. No.: US 2018/0037009 A1
(43) Pub. Date: Feb. 8, 2018

(54) WOOD DERIVED MULTILAYER PRODUCT WITH INTEGRATED ELECTRIC CIRCUIT AND MANUFACTURING PROCESS

(71) Applicants: CENTITVC- CENTRO DE NANOTECNOLOGIA E MATERIAIS TÉCNICOS, FUNCIONAIS E INTELIGENTES, Vila Nova De Famalicão (PT); SONAE - INDÚSTRIA DE REVESTIMENTOS, S.A, Miaia (PT)

(72) Inventors: João Manuel CARVALHO GOMES, RUÍLHE (PT); Joana DINIZ DA FONSECA, MAIA (PT); Jaime Rafael PINTO LOPES, GUIFÕES (PT); Bruna Gabriela SILVESTRE MENDES PINTO DE MOURA, VILA NOVA DE FAMALICÃO (PT); José Joaquim POÇAS GONÇALVES, BRAGA (PT); Miguel António BASTOS DA SILVA, SANFINS VFR (PT); Miguel ROCHA FELGUEIRAS DE SOUSA NOGUEIRA, LEÇA DA PALMEIRA (PT); Cristina Isabel DE MELO MAIA, BRAGA (PT); Paulo Jorge RIBEIRO DA CRUZ, ALVARÃES (PT); João Miguel MACIAS FERRA, SÃO FELIX DA MARINHA (PT); Neuza Patrícia FARIA RAMOS TAVARES, SÃO FELIX DA MARINHA (PT); Pedro Miguel PACHECO NEVES CARTEADO MENA, LEÇA DA PALMEIRA (PT)

(21) Appl. No.: 15/550,601

(22) PCT Filed: Feb. 15, 2016
(86) PCT No.: PCT/IB2016/050804

§ 371 Date: Aug. 11, 2017

(30) Foreign Application Priority Data
Feb. 13, 2015 (PT) 108227

(51) Int. Cl. B32B 21/02; B32B 21/06; B32B 7/12; B32B 29/06; B32B 37/18; B32B 38/00; A47B 96/20; B32B 29/00

(52) U.S. Cl. CPC B32B 21/02; A47B 96/206; B32B 21/06; B32B 29/005; B32B 29/06; B32B 37/18; B32B 38/145; B32B 7/12; B32B 2255/12; B32B 2255/26; B32B 2260/028; B32B 2260/046; B32B 2317/12; B32B 2317/122; B32B 2439/00; B32B 2451/00; B32B 2457/00; B32B 2457/08; B32B 2471/00; B32B 2479/00; B32B 2607/00; B32B 37/12

(57) ABSTRACT

Wood derived multilayer glued or laminated product having an integrated electric circuit, comprising a paper layer and conducting elements of conductive ink deposited on said paper layer, said elements being suitable for forming an electric circuit and said paper layer has a rugosity inferior to 60 μm. The paper layer may be of kraft paper. The product may comprise one or more additional kraft paper layers, in particular having a hole for receiving electric components such that the top surface of product remains flat. The product may include a fibreboard substrate of MDF. The paper layer may be a decorative paper layer glued with the circuit facing the substrate. The manufacture process comprises depositing conductive ink elements on a paper layer having rugosity inferior to 60 μm for forming an electric circuit; and incorporating, by gluing or laminating, said paper layer into the multilayer product.

### TECHNICAL FIELD

The present disclosure refers to wood derived multilayer products, profiles, framed, laminate or compact products, among others, with integrated electric circuits, for example capacitive sensors, and the fabrication process thereof.

### BACKGROUND

PT1536065E describes a decorative paper for use in a floor panel surface with application of quaternary ammonium compounds in a mixture of resin. The resin can be urea or melamine resin, and the mixture can also include abrasion resistant particles, such as corundum. Said mixture, applied to the paper, gives it antistatic properties, so that when it is used in flooring panels, there is a reduction of static electricity generated by people when they walk on the panels. US2003136494A1 describes a floor plank, multi-layer, of laminate pressed panels, that comprises on the superior part a decorative paper, on the layer that is intended to be walked on, which is impregnated with aminoplastic resins or similar. The particles of an electricity conductive material are applied on the back of the decorative paper. GB572267 describes a laminate for similar uses to that of wood, with a reinforcing core of textile strings and metal wires. The core is joined to the veneers via a synthetic resin, with the help of heat and pressure. The veneers or the textile can be impregnated with resin, for example, a denatured alcohol solution of a phenol resin or urea-aldehyde. The resin can be applied to a sheet of fabric paper inserted between the fabric and the veneers. Vinyl resins can be used.

These facts are disclosed in order to illustrate the technical problem addressed by the present disclosure.

### SUMMARY

The disclosure includes a wood derived multilayer glued or laminated product having an integrated electric circuit, comprising a paper layer and conducting elements of conductive ink deposited on said paper layer, said elements being suitable for forming an electric circuit and said paper layer has rugosity (i.e. roughness) inferior to 60 μm. In order to preserve a flat top surface of the final product, a low rugosity of the paper layer is important. However, if the rugosity is too low, the adhesion of the conductive ink is impaired. Preferably, the rugosity is between 20 μm and 50 μm.

Rugosity is measured by stylus profilometer using Average Roughness Ra (raw)—which is the arithmetic average of the absolute values of the profile height deviations recorded within the evaluation length (L) and measured from the mean line:

Ra=(|Z1|+|Z2|+|Z3| . . . |ZN|)/N.

The evaluation lengths are the lengths of the areas where the conducting elements of conductive ink are to be deposited, i.e. lengths over substantially all the area where the conducting elements of conductive ink are to be deposited. However, measuring the rugosity over a representative length of the area where the conducting elements of conductive ink are to be deposited is enough, because paper rugosity is a substantially uniform characteristic of paper and it is well known how to control for this uniformity.

Rugosity (i.e. roughness) was measured using stylus profilometer KLA TENCOR D-100.

The thickness of the conductive elements of deposited conductive ink should preferably not be higher than 20 μm in order to keep unchanged the surface appearance of the multilayer product, for example, causing saliencies on the surface of the product.

In order to preserve a flat top surface of the final product, the relationship between the thickness of the conductive elements of deposited conductive ink and the rugosity (i.e. roughness) of the paper layer is also important, namely a relationship of substantially of 1 to 3.

For printed layers or films with the thickness equal or below 20 μm, the rugosity (i.e. roughness) of the paper to be printed should be less than 60 μm in order to obtain printed layers or films without electrical discontinuities.

The paper layer receiving deposited conductive elements can be of kraft paper. Kraft paper has shown to be capable of accommodating the thickness of the deposited elements thus preserving a flat top surface of the final product.

Also, when the product comprises a fibreboard substrate and only a paper layer of decorative paper layer glued onto said substrate, it is advantageous that the conducting elements are deposited on the face of the decorative paper layer facing the substrate, and not the substrate, which is better at accommodating the thickness of the deposited elements thus preserving a flat top surface of the final product. This may also be explained by said rugosity of the paper layer.

The present disclosure describes a wood derived multilayer product with integrated sensors and electric circuits comprising a paper layer, with rugosity (i.e. roughness) inferior to 60 μm and resistance to 80° C. temperatures, upon which a conductive ink is deposited in conductive elements forming an electric circuit or sensor.

In an embodiment, the rugosity of the paper layer used in the multilayer product is comprised between 20 μm and 50 μm.

In another embodiment, the paper layer of the multilayer product is resistant to 200° C. temperature.

In another further embodiment, the electric circuit of the multilayer product comprises capacitive or resistive sensors of proximity detection at its surface and/or presence of objects and/or presence of water.

In an embodiment, the capacitive sensor of the multilayer product is composed of one or two interdigitated electrodes.

In another embodiment, the electrode used on the capacitive sensor of the multilayer product presents the form of intercalated combs or fingers.

In another further embodiment, the multilayer product comprises at least an additional paper layer placed on or under the paper layer containing the electric circuit.

In an embodiment, the multilayer product comprises at least a hole in the paper layer for the passage of electric connections to the conductive elements of the electric circuit.

In another embodiment, the multilayer product comprises the integration of light emitters.

In another further embodiment, the electronics of the multilayer product are connected to the printed sensor by clamping of a metallic connector onto an end of the sensor.

In an embodiment, the multilayer product comprises a recess for accommodating the electronic control unit.

In another embodiment, the multilayer product comprises electric components of the electric circuit on the paper layer of the electric circuit, clamped on the conductive elements.

In another further embodiment, the multilayer product comprises a decorative paper layer on the layer or layers of paper.

In an embodiment, the paper used in the multilayer product is simple paper, paper impregnated with melamine resin, kraft paper, kraft paper impregnated with phenolic resin, photographic paper, digital paper, polymeric film or decorative paper.

In another embodiment, the conductive ink used in the multilayer product is of solvent base, aqueous base, or oily base.

In another further embodiment, the conductive ink used in the multilayer product contains at least a conductive material and/or polymeric material.

In an embodiment, conductive ink used in the multilayer product contains silver and/or copper and/or carbon and/or graphite and/or platinum and/or PEDOT:PSS.

In another embodiment, the resistive sensor used in multilayer product is constituted by carbon or ceramic films with a positive temperature coefficient.

In another further embodiment, the multilayer product is a compact, laminate, profile or framed product.

The present disclosure further describes the fabrication process of wood derived multilayer product with an integrated electric circuit, which comprises the following steps:
depositing conductive ink on a paper layer, in a roll or sheet by sheet, forming an electric circuit including conductive elements;
arranging the paper layer with at least one electric circuit on a wood derived substrate, or under or on at least one paper layer;
laminating the wood derived substrate and the paper layer with electric circuit;
and/or pressing the paper layers together with the paper layer with electric circuit;
connecting the printed circuit by clamping onto the electronics.

In an embodiment, the fabrication process of the multilayer product further comprises the integration step of the light emitters on wood derived products, comprising the following steps:
depositing conductive tracks on paper, the track being for example able to constitute conductive matrices;
placing light emitters through an automatic or manual system of component placing;
arranging the paper layer with conductive tracks/matrices and integrated light emitters on or under one or several paper layers;
drilling/cutting out the subjacent papers, in order to compensate for the relief caused by integrated light emitters;
pressing the paper layers together with the paper layer with conductive tracks/matrices and integrated light emitters;
connecting the printed track by clamping onto the electronics.

In another embodiment, the conductive ink used in the fabrication process of the multilayer product is deposited by printing, offset printing, rotogravure, serigraphy, flexography, rotary serigraphy, inkjet or spraying.

In another further embodiment, the fabrication process of the multilayer product comprises the clamping of electric components on the said conductive elements, on or under the paper layer of the electric circuit.

### General Description

The present disclosure refers to wood derived multilayer products, profiles, framed, laminate or compact products, among others, with integrated sensors and electric circuits, and fabrication process thereof.

Advantageously, the disclosure does not alter the superficial appearance of these products, namely its flatness, and does not require significant changes to the machinery used in its manufacture process.

The manufacture process of wood derived products having printed electric circuits in paper, or impregnated paper with resin, normally require high pressure and temperature conditions for the development of the final wood profile, wood derived, laminate and compact products.

The products described in this disclosure, together with all the electronics for acquisition, processing and control of signals read by sensor systems, have an improved usefulness, without changing the superficial aspect, main mechanical properties and of the durability of the wood derived products.

It is important that the electric circuit integration process is compatible and withstands the conditions of processing and fabrication of these products.

The solution described herein can be integrated in laminate and/or compact products, used, for example, in furniture or floor coating, as well as wood profiles and/or framed products, for example skirting boards, door and window frames, floor profiles, door coatings, cabinets and/or tables, furniture in general, floor coatings or wall coatings.

The present solution is particularly useful for the detection of floods; for products activated by touch, for example with light emission, sound emission, or another previously defined output, like for example the counting of steps at the entrance of buildings; for products with fully integrated light emitters and which are not visible, without changing their original appearance. The sensors allow for the functionalization of the pieces wherein they are integrated in, since, for being for example sensitive to the presence of water and/or touch, together with the necessary electronics, they allow, for example, the parts to detect floods or activate a given predefined exit.

The present disclosure relates to wood derived multilayer products, profiles, framed, laminate or compact products, among others, with sensors and electric circuits that include conductive elements, wherein said conductive elements are of conductive ink deposited on one of the paper layers.

The printing ink contains conductive materials, for example silver, copper, nickel, carbon, graphite, platinum, polymeric conductive materials, like for example poly(3,4-ethylenedioxythiophene) doped polystyrene sulphonate, commonly named as PEDOT:PSS. The conductive ink can be of solvent base, aqueous base, or oily base.

In the sensor printing process, printing techniques like serigraphy, rotogravure, spraying, flexography, rotary serigraphy, printing by ink jet (inkjet) and/or offset printing are, among others, possible. The printed sensors can be of the capacitive sensor or resistive sensor type or others that can be printed.

In an embodiment, the capacitive sensor is formed by an electric circuit composed of two interdigitated electrodes, for example with the form of a comb or intercalated fingers, or by two electrodes with the form of a nucleus and a ring, and can be formed according to a pre-defined geometric shape, the ring being around the nucleus, or of only one electrode.

In an embodiment, said electric circuit comprises capacitive electrodes to detect touch or proximity to its surface and/or the presence of objects and/or the presence of water in its proximity.

Resistive sensors also can be used, which are based on variations of resistance, being used for namely detecting physical quantities variations like temperature, pressure and the concentration of a particular substance. These sensors include at least two electrodes which can also be printed. In an embodiment, resistive sensors are also constituted by functional materials which can be processed by printing techniques, as is the case of some carbon films or PTC ceramics (Positive Temperature Coefficient) so that the sensor itself is printed together with the electric circuit.

Printing can be performed on different paper typologies like for example polymeric film, paper, decorative paper, paper impregnated with for example melamine resin, kraft paper, kraft paper impregnated with for example phenolic resin, photographic paper, decorative paper, digital paper.

Kraft paper is a type of paper manufactured from a mixture of long and short cellulose fibres, originating from soft wood pulps. This mixture of fibres provides mechanical resistance characteristics with a good processing performance on machines and a relative softness.

The paper may be recoated with paraffin or also laminate with polymers, eg. plastic resins, particularly recoated or laminate with heat, provided that it retains its adhesive characteristics, mechanical resistance and softness for the described embodiments.

The paper should exhibit properties adequate to the printing process, namely superficial rugosity not superior to 60 μm, preferably comprised in the range between 20 μm and 50 μm and withstanding temperatures superior to 80° C., preferably between 80 and 200° C., without losing the adequate characteristics necessary to the underlying processes.

Different resin content and/or a prolonged exposure of the paper to high temperatures (superior to 100° C.) can provoke an accentuated loss of moisture, making it brittle, lacking the resin content suited for the fabrication process. Therefore, their use could compromise the final characteristics of the product. As such, the temperatures and exposure times of paper for curing the printing ink should be controlled.

Taking into consideration the values of rugosity and curing conditions (time and temperature), the amount of printed ink per unit of area shall be adjusted according to the specificity of the paper so that the response obtained from the sensor will not be compromised.

In an embodiment the circuit is printed on decorative paper being glued by lamination or by thermo-adhesives applied by fusion or reactive polymers to a plate of MDF or HDF or other wood derived substrate such as fibreboard, for example, particle board.

In this embodiment, the conductive elements are deposited on the side of the paper layer facing the substrate. In this embodiment, the printed sensor is integrated in products that can be used as profiles in wood and derivatives.

In another embodiment, the circuit is printed on impregnated decorative paper or on impregnated kraft paper, constituting a multilayer structure, comprising one or more additional paper layers on or under the paper layer of the electric circuit which will be pressed, according to very high pressure and temperature conditions, for the formation of laminate and/or compact products.

One of the main differences between laminate and compact products is in the thickness of the final product, the laminate products being normally produced in thicknesses up to 2 mm and compact products having thicknesses above 2 mm.

In this embodiment, said additional layers comprise at least a hole for the passage of electric connections to the conductive elements of said electric circuit.

This disclosure further describes the integration of light emitters, such as LEDs, in wood derived products with integrated sensorisation. These light emitters can be activated by touch or proximity, or another that is meant to be defined, to the integrated sensor.

For multilayer products with light emitters these are integrated almost invisibly, without significant change in the original appearance of the wood derived product. LEDs of small dimensions are integrated by printing conductive tracks on paper, the tracks being for example able to constitute conductive matrices.

In an embodiment, in case the wood derived products are laminate or compact products, a perforation/snip of the subjacent papers is made so that the component can withstand higher pressures. After being subjected to pressing, the final appearance is identical to a laminate and/or compact product without an integrated light emitter.

The paper is preferably kraft paper. The light emitters can be placed preferably by an automatic or manual system of component placing, like for example a Pick&Place machine. The perforation may preferably be made by laser and the printing of conductive tracks using the printing techniques and inks aforementioned.

The printed electric circuits are connected to the electronics for acquisition, control and processing of the signal generated by the sensors.

An embodiment further comprises electric components of said electric circuit deposited on the paper layer, in particular by printing, offset printing, rotogravure, flexography, rotary serigraphy, inkjet or spraying, for example resistors, capacitors, or others.

With regard to the wood profiles and derivatives the electronics is connected to the printed sensor by setting, in other words, by clamping of a metallic part on the extreme end of the sensor, where connections to the electronic components required to the acquisition and/or signal transmission are clamped or welded. For the laminate and compact products, the electronics is welded by conventional methods in the rear part of the product.

This hardware is thus located in the non visible part of the multilayer products, being protected by a box and/or encapsulant.

An embodiment comprises a recess for accommodating this electronic control unit connected to said electric circuit.

In another embodiment electric connections of said electric circuit are predicted for other integrated electric circuits in other products of wood profiles or derivatives, laminate or compact products.

This extension can be embedded in the remaining pieces that constitute, for example, the skirting boards, floor coatings or the profiles, which are also installed in the same zone of the building, but without integrated electronics. Thus, it is possible to extend circuits over one or more divisions through the interconnection between said pieces.

In an embodiment, in the case of the electric supply, the cable runs by the piece where the sensor is integrated and ends with a connector which makes the connection to the extension needed for its connection to the electric current of the building.

For the acquisition and transmission of signal various electronic components are integrated. The signal from the electric transducer enters the circuit of signal conditioning, in order to treat this signal, so that afterwards it can be read by the (ADC) analogical to digital converter. The signal after being digitalized (converted into digital), will be encapsulated in a dataframe and will be transmitted by the communication interface to another location where this data can be analysed, shown to the end user or serve as “inputs” for other devices. Data can be transmitted by wireless communication interfaces, such as WiFi and Bluetooth.

The signal transmission by a wireless network allows, namely in the case of flooding, sounding of an alarm, sending a text message to the mobile phone of the user of the skirting board or, for example, turning off the building's water supply. For the light emitters, the activation of sensor allows for example the activation of the LED, or another output unit that the user considers of interest, which can be previously defined.

The circuit power supply is preferably 5 V, the voltage being converted from the 220 VAC in continuous 5 V. This can be done, for example, through an induction circuit or by rectification of the AC signal.

The present solution thus concerns a fabrication process of wood derived multilayer products with an electric circuit including:
depositing conductive ink on a paper layer for obtaining a printed electric circuit including conductive elements;
arranging the paper layer with one or more electric circuits on a substrate of wood derivatives or on a multilayer structure constituted by papers which is subsequently subject to predefined pressure and temperature conditions;
connecting the printed circuit by clamping to the electronics for acquisition, control and/or signal processing;
optionally, integrating light emitters almost in an invisible way in the wood derived products.

### BRIEF DESCRIPTION OF THE DRAWINGS

The following figures provide preferred embodiments for illustrating the description and should not be seen as limiting the scope of invention.

FIG. 1: Schematic representation of the printing technique by serigraphy.

FIG. 2: Schematic representation of the fabrication process of the profiles.

FIG. 3: Schematic representation of the profile with integrated flood sensor.

FIG. 4: Representation of the integration of the sensor on a laminate product.

FIG. 5: Representation of the integration of light emitters on laminate and compact products.

FIG. 6: Schematic representation of the perforation of decorative papers, kraft paper, via laser, and connections.

FIG. 7: Schematic representation of connections for the laminate products, compact products and for the profiles.

### DETAILED DESCRIPTION

FIG. 1 shows an embodiment of the printing process of the sensor and/or matrices, where the printing technique used is serigraphy. The raw material used is preferably silver based conductive ink. Briefly, in serigraphy, the ink is placed on a screen wherein a negative of the pattern which is intended to be printed is blocked, a squeegee being used in order to force the passage of ink through the regions of the screen that are not locked to the substrate. After printing the patterns are subjected to a thermal cure, according to the specifications of the ink.

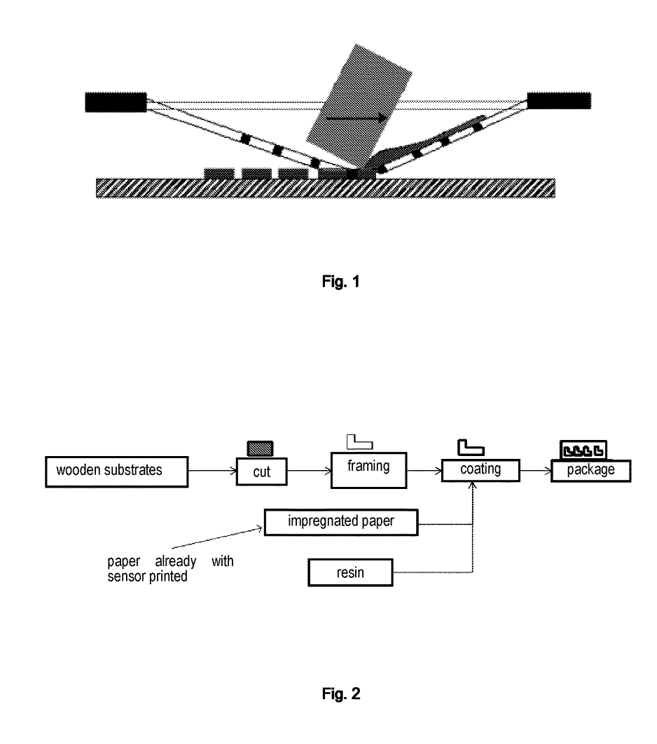

FIG. 2 shows an embodiment of the sensor's integration into the profile, namely in skirting boards and/or wood frames. The profiles are produced with substrates or wood derivatives and coated with decorative papers, namely through the gluing process at low pressure with thermo-adhesives applied by fusion or reactive polymers. In phase 1, the cutting phase, the substrate is chopped into strips according to the width of the profile and cut longitudinally. In phase 2, the framing phase, through the combination of the various cutting blade tools, the longitudinal thinning of the previous substrate strip is performed to give it the “outline” of the intended cross-profile. The achieved product is called a frame. Prior to stage 3, the coating stage, there is an intermediate cutting phase of the impregnated paper roll with sensorisation printed on the width which it is intended to coat the frame in. In step 3, the coating operation is executed all on a single machine, which consists of:
gluing the paper with printed sensors, through a proper applicator, like for example by hot melt technology using thermal-adhesives or reactive polymers and under controlled temperature and humidity conditions;
proceeding with the simultaneous advancement of the frame and glued paper;
“adjusting”, under pressure and temperature, the paper to the format of the frame profile, through at least two rollers of a polymeric material;
stabilizing the gluing;
cutting to length for fine tuning the final dimension.

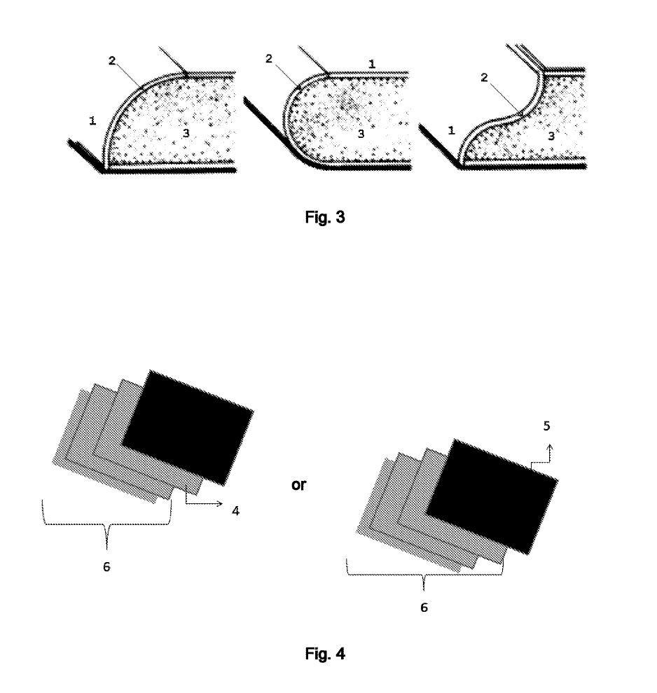

FIG. 3 shows an embodiment of the integration of sensor 2 on the profile, in particular on skirting boards and/or wood frames, via the profile with sensor 2 integrated. Sensor 2 is printed on the decorative paper 1, on the face that is facing the substrate or wood derivative of the profile, in other words, of substrate 3. The sensor 2 is located on the exposed face of the profile.

FIG. 4 shows an embodiment of the integration of the sensor on the laminate or compact product. Simply put, the laminate or compact products are produced using a set of sheets of paper impregnated with resin that after subject to high pressure and temperatures form a single product of high resistance. At the top of this set of sheets of paper an impregnated decorative paper 5 is placed and on the base various kraft paper sheets 6 are placed. The larger the number of kraft paper sheets used the higher the thickness of the final material. The thickness of the final product defines if this is a high pressure laminate (HPL) or a compact one. The sensor can be printed, by the techniques previously mentioned, on the face of the decorative paper that is not exposed to surface 5 or on the first sheet of kraft paper constituent of the laminate product 4. The remaining kraft paper sheets 6 are perforated, via laser, in order to expose the electrode of the sensor for connection to the electronics needed for signal acquisition and transmission. After being subject to the pressing the final aspect of this laminate product is identical to that of a laminate or compact product without integrated sensor.

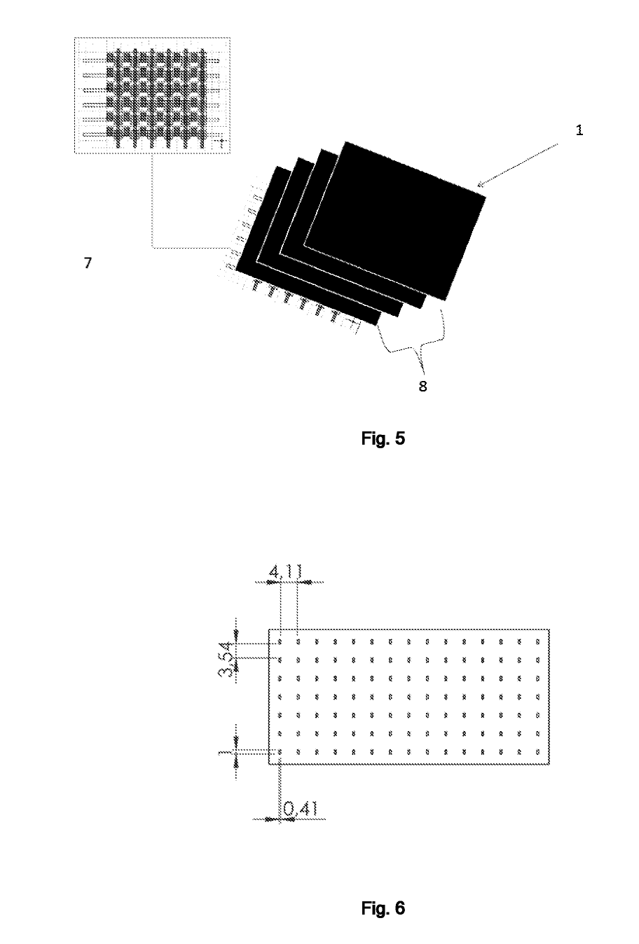

FIG. 5 shows an embodiment of the integration of light emitters on the laminate and compact products, with decorative paper 1, with the first kraft with printing of a conductive matrix and placing of the light emitters 7, for example LEDs (light emitting diode), and with kraft paper perforated via laser in the LED area 8. Light emitters can be integrated, for example small dimension LEDs on the laminate and compact products, with the use of a Pick&Place machine and laser perforation of the subjacent papers for the component to resist to high pressure. After being subjected to pressing, the final aspect of this laminate product is identical to a laminate and/or compact product without an integrated light emitter.

FIG. 6 shows an embodiment of the perforation of kraft papers, via laser, and connections. The perforation of kraft papers for placement of the light emitters is carried out in a precise way, according to the size of the LED used, in other words, length and width, via laser. With this perforation the LED is perfectly fitted in in the kraft papers, not being visible on the laminate product after the pressing test. This process is important so that the LED resists high pressure pressing. The same typology of process can be used for perforation of kraft paper on the sensor electrodes region for posterior connection to the electronics needed for signal processing.

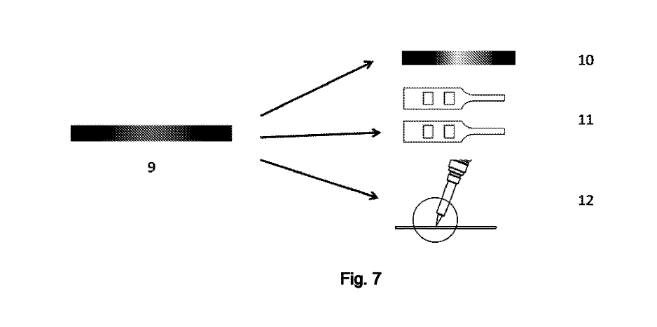

FIG. 7 shows an embodiment of the connections, for the laminate products, compact products and/or profiles. The connections are made with the use of different types of connectors, so that the sensors and/or printed tracks 9 are not damaged. The connectors are used for driving the signal among the control system, the power supply and the sensors. For this purpose metallic connectors are used whose application can be performed by crimping 11 and/or welding 12 allowing a quick fit in, and/or conductive metallic strips 10 with adhesive properties whose application can be made by gluing, and/or conductive metallic wires fixed on the substrate by crimping 11, welding 12 or both. The same system of connectors is used to make the connection to external AC power systems, through the connections between integrated hardware DC (AC/DC converter) and conventional electric installation.

### Example 1

Moisture/flooding detector profile. Within the scope of this technology, wood derived profiles or skirting boards can be developed capable of detecting moisture/flooding. The flood sensor consists of a interdigitated capacitive sensor printed on decorative paper in a roll-to-roll system by conventional printing techniques and with recourse to solvent based conductive inks. The decorative paper with printed sensorisation is glued by thermal-adhesives applied by fusion or reactive polymers to wood substrates (MDF or HDF, fibreboard) for the development of skirting board/profile capable of detecting the presence of water. On the face that is not exposed of the wood substrate a hole is made for fitting of the electronics for signal acquisition and processing. This includes a wireless communication system for sending alerts to the user in case of flooding or the increasing of the value read by the sensor for values superior to the previously defined. This system also allows a constant control by the end user, by consulting the signals read by the sensor on a database. This control and monitoring can be done on-site or remotely.

In an embodiment, for detecting floods, interdigitated capacitive sensors with two electrodes and system for signal acquisition and transmission thereof are integrated. This type of sensor allows the detection of the presence of water through the variation of the capacity of the condenser formed between the two electrodes. This sensor, in contact with water, by reaching a previously defined value sends an alert to the user, or to the mobile phone or to the computer and can also close the main water supply of the house, namely it can close doors and/or shutters, according to the user's interest. The communication of this control unit can be, for example, by Bluetooth, wireless network, with local alert, for example by use of domotics, or GSM (global system for mobile communications) or GPRS (General Packet Radio Service), with an alert from a distance, for example with the resort to a smartphone (smart phone).

### Example 2

Laminate and compact products with integrated light emitters. Matrices or conductive tracks with inks on kraft paper are printed on roll-to-roll systems or on sheet-to-sheet systems. Small dimension light emitters on the cells that form the conductive matrix are integrated with resort to Pick&Place systems. Paper blocks for the development of laminate and compact products are built with the following characteristics from the base to the top:
perforated kraft paper for the connection of the electronics to the conductive matrix;
kraft paper with a printed conductive matrix and integrated light emitters;
perforated kraft paper on the area of light emission;
decorative paper.

This set is subject to high pressure and temperature conditions, giving way to a unique structure with high mechanical resistance. The final product is connected by cable to the electronic systems for the activation of the light emitters according to pre-defined patterns.

### Example 3

Laminate and compact products with light emitters and integrated touch sensors. The light emitters of Example 2 can be activated by touch action on the surface of the laminate or compact product or profile or framed product. The touch sensor is printed on decorative or kraft paper with resort to roll-to-roll or sheet-to-sheet printing techniques with solvent based conductive inks. This decorative or kraft paper with printed sensorisation is an integrated part of the set of papers previously described for the development of laminate or compact products. The subjacent kraft papers are perforated for the connection to the signal acquisition and processing electronics. This entire set is subject to high pressure and temperatures conditions for the development of a unique structure and of high resistance. The laminate or compact products when subject to touch or approach to its surface activate the light emitters that are an integral part of its structure.

### Example 4

kraft paper—kraft paper is a type of paper of high resistance with a cellulose base. Examples include papers for printing and writing; fabrics, coffee filters and other consumer products; and specialized applications, such as fibre cement and Japanese washi paper. A particular type of kraft paper used in this technology is referred to as of whitened soft wood, septentrional kraft or NBSK (northern bleached softwood) pulp. It is sought for its diversity of applications, and for its high strength, porosity and other functional advantages. As an example of kraft paper manufacturers the Catalyst Today's Paper, Gascogne Paper, Horizon Pulp and Paper Ltd can be considered, or for example other members of CEPI Eurokraft—European Association for kraft paper producers, for the Sack Paper Industry and kraft paper for packaging industries.

### Example 5

Conductive ink—The printing ink used contains conductive materials, in particular silver, copper, nickel, carbon, graphite, platinum, polymeric materials, as for example PEDOT:PSS, among others. This ink should have good thermal and mechanical properties in order to withstand the conditions of the process. As an example of manufacturers and suppliers of this type of paint one can consider Heraeus Electronic Materials Division and Agfa.

The term “comprising” whenever used in this document is intended to indicate the presence of stated features, integers, steps, components, but not to preclude the presence or addition of one or more other features, integers, steps, components or groups thereof. It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

The disclosure should not be seen in any way restricted to the embodiments described and a person with ordinary skill in the art will foresee many possibilities to modifications thereof. The above described embodiments are combinable. The following claims further set out particular embodiments of the disclosure.

1. A wood-derived multilayer glued or laminated product having an integrated electric circuit, comprising a paper layer and conducting elements of conductive ink deposited on said paper layer, said elements forming an electric circuit and said paper layer having a surface roughness less than 60 μm.

2. The product according to claim 1, wherein the surface roughness is between 20 μm and 50 μm.

3. The product according to claim 1, wherein the thickness of the conductive ink is less than 20 μm.

4. The product according to claim 1, wherein said paper layer is of kraft paper.

5. Product according to claim 1, further comprising a plurality of kraft paper layers.

6. The product according to claim 5, wherein one or more of the plurality of kraft paper layers has a hole for receiving one or more electric components of the electric circuit, whereby the top surface of multilayer product is flat.

7. The product according to claim 1, further comprising a top decorative paper layer.

8. The product according to claim 1, further comprising a fibreboard substrate, wherein said fibreboard is a MDF board, a HDF board or a particle board.

9. The product Prod ii according to claim 1, further comprising a fibreboard substrate, wherein said paper layer is a decorative paper layer attached to said substrate by glue, wherein the conducting elements are disposed on the face of the decorative paper layer facing the substrate.

10. (canceled)

11. (canceled)

12. (canceled)

13. The product according to claim 1, wherein one or more of the deposited electric components is contiguously connected to one or more of the conducting elements of deposited conductive ink.

14. (canceled)

15. The product according to claim 1, wherein a portion of the conductive ink is arranged to comprise two interdigitated finger electrodes to define a capacitive sensor.

16. (canceled)

17. The product according to claim 1, wherein the paper layer is selected from the group consisting of: plain paper, paper impregnated with melamine resin, kraft paper, kraft paper impregnated with phenolic resin, photographic paper, digital paper, polymeric film, and decorative paper.

18. (canceled)

19. The product according to claim 1, wherein the kraft paper is selected from the group of: plain kraft paper, impregnated kraft paper, and kraft paper impregnated with phenolic resin.

20. The product according to claim 1, wherein the conductive ink is solvent based, aqueous based, or oil based.

21. (canceled)

22. (canceled)

23. (canceled)

24. A process for the manufacture of a wood derived multilayer glued or laminated product having an integrated electric circuit, comprising the steps of:
providing a paper layer having a surface roughness less than 60 μm;
depositing conducting elements of conductive ink on said paper layer for forming an electric circuit; and
incorporating, by gluing or laminating, said paper layer into the multilayer product.

25. The manufacturing process according to claim 24, further comprising the steps of:
arranging the paper layer with deposited electric circuit on a wood derived substrate; and
pressure gluing the substrate with the paper layer having the deposited electric circuit on the face towards said substrate.

26. The manufacturing process according to claim 24, further comprising the steps of:
arranging the paper layer with deposited electric circuit on, or under, or between a plurality of additional paper layers; and
laminating all the paper layers onto a wood derived substrate.

27. The manufacturing process according to claim 26, further comprising drilling or cutting one or more holes in the additional paper layers in order to compensate for the relief caused by the electric circuit or by any component of the electric circuit, such that the top surface of the final multilayer product is flat.

28. (canceled)

29. The manufacturing process according to claim 24, wherein the conductive ink is deposited by one of printing, offset printing, rotogravure, serigraphy, flexography, rotary serigraphy, inkjet, and spraying.

30. Manufacture process according to claim 24, further comprising clamping the electric component or electric components of the electric circuit onto said conductive elements through the paper layer of the electric circuit.
